(19) United States
(12) Patent Application Publication
(10) Pub. No.: US 2024/0331129 A1
(43) Pub. Date: Oct. 3, 2024

(54) LEARNING DEVICE, LEARNING METHOD, AND NONDESTRUCTIVE INSPECTION SYSTEM

(71) Applicant: Panasonic Intellectual Property Management Co., Ltd., Osaka (JP)

(72) Inventor: Naganori SHIRAKATA, Osaka (JP)

(21) Appl. No.: 18/290,660

(22) PCT Filed: Mar. 17, 2022
(86) PCT No.: PCT/JP2022/012178

§ 371 Date: Jan. 19, 2024

(30) Foreign Application Priority Data
Jul. 21, 2021 (JP) 2021-120434

(51) Int. Cl. G06T 7/00; G06T 7/90

(52) U.S. Cl. CPC G06T 7/0004; G06T 7/90; G06T 2207/10024; G06T 2207/20081; G06T 2207/20084

(57) ABSTRACT

A learning device that comprises a preprocessing circuit and a learning circuit. The preprocessing circuit performs processing that converts the relative phase differences and relative intensity differences between a plurality of transmission/reception waves that are based on the radiation of electromagnetic waves at a measured object into a color image. The learning circuit uses first color images that have been processed by the preprocessing circuit and training data that associates second color images and types of internal states for measured objects to learn an identification model for identifying the types of internal states.

### TECHNICAL FIELD

The present disclosure relates to a learning apparatus, a learning method, and a nondestructive inspection system.

### BACKGROUND ART

In a product inspection in a manufacturing process of industrial products and foods, there is a need to grasp the internal state of a product, which is difficult to confirm by the visual observation of the user. For example, even when the surface of a product is in a trouble-free state, a bubble and/or a defect may be present inside the product or a foreign object may be mixedly present therein. For example, although there is a case where a nondestructive inspection of a product is performed by using an X-ray inspection apparatus, cost and safety have been taken into consideration.

Given the above, there is a growing demand for a nondestructive inspection system that uses a radio wave whereby an inspection can be performed more easily and safely.

As a technique of detecting a foreign object by using a radio wave, for example, Patent Literature (hereinafter referred to as “PTL”) 1 discloses a technique in which reflection waves of radio waves transmitted from a transmitter are received by a plurality of receivers and, in a case where a phase difference between the reception waves exceeds a predetermined threshold, it is determined that there is a foreign object near a power receiver.

### CITATION LIST

### Patent Literature

### PTL 1

Japanese Patent Application Laid-Open No. 2014-207749

### SUMMARY OF INVENTION

### Technical Problem

Incidentally, it is considered that a case where, in a product inspection, it is possible to identify the type of the internal state of a product (for example, whether a bubble is present inside the product or whether a metal piece is mixed therein) in addition to detecting the presence or absence of a foreign object inside the product can contribute to further improvement in the quality of the product.

In a configuration in which the presence or absence of a foreign object is determined as in the technique described in PTL 1, however, only a simple threshold determination is performed, and thus, it is difficult to identify the type of the internal state of a product. Further, for example, in a case where a machine learning algorithm by learning using various training data is applied, internal state detection based on a phase difference between reception waves may involve occurrence of a phase jump, and thus, there is room for consideration regarding a system for determining phase unwrapping.

As described above, with respect to learning for detecting a foreign object inside an object to be measured and for identifying the type of the foreign object by learning using training data, there has been room for consideration in terms of the accuracy thereof.

One non-limiting and exemplary embodiment facilitates providing a learning apparatus, a learning method, and a nondestructive inspection system each capable of performing learning for accurately identifying the type of the internal state of an object to be measured, which is used in training data.

A learning apparatus of an exemplary embodiment for the present disclosure includes: preprocessing circuitry, which, in operation, performs processing of converting relative phase differences and relative intensity differences between a plurality of transmission/reception waves based on radiation of radio waves to an object to be measured into a color image; and learning circuitry, which, in operation, learns, by using a first color image and training data, an identification model for identifying a type of an internal state of the object to be measured, where the training data are training data in which a second color image and the type of the internal state are associated and the first color image and the second color image being processed by the preprocessing circuitry.

A learning method of an exemplary embodiment for the present disclosure is a learning method of a learning apparatus that identifies an internal state of an object to be measured. The learning method includes: performing processing of converting relative phase differences and relative intensity differences between a plurality of transmission/reception waves based on radiation of radio waves to the object to be measured into a color image including hue, saturation, and value; and learning, by using a first color image and training data, an identification model for identifying a type of the internal state, where the training data are training data in which a second color image and the type of the internal state are associated and the first color image and the second color image being processed.

A nondestructive inspection system of an exemplary embodiment for the present disclosure includes: preprocessing circuitry, which, in operation, performs processing of converting relative phase differences and relative intensity differences between a plurality of transmission/reception waves based on radiation of radio waves to an object to be measured into a color image including hue, saturation, and value; learning circuitry, which, in operation, learns, by using a first color image and training data, an identification model for identifying a type of an internal state of the object to be measured, where the training data are training data in which a second color image and the type of the internal state are associated and the first color image and the second color image being processed by the preprocessing circuitry; identification circuitry, which, in operation, identifies, by using the identification model, the type of the internal state of the object to be measured according to the first color image; and a monitor, which, in operation, displays an identification result of the identification circuitry.

It should be noted that general or specific embodiments may be implemented as a system, a method, an integrated circuit, a computer program, a storage medium, or any selective combination thereof.

According to an exemplary embodiment of the present disclosure, it is possible to perform learning for accurately identifying the type of the internal state of an object to be measured, which is used in training data.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a configuration diagram illustrating an example of a nondestructive inspection system in an embodiment of the present disclosure;

FIG. 2 is a diagram provided for describing a color image in the HSV color space in the present embodiment;

FIG. 3 is a diagram provided for describing conversion processing into a color image in the HSV color space by a preprocessor;

FIG. 4 is a configuration diagram illustrating an exemplary learner and an exemplary identifier in the embodiment of the present disclosure;

FIG. 5A illustrates feature vectors within an embedding space before learning;

FIG. 5B illustrates the feature vectors within the embedding space after the learning;

FIG. 6 is a flowchart illustrating an operation example of learning control by the learner of the nondestructive inspection system;

FIG. 7 is a flowchart illustrating an operation example of inspection control in the nondestructive inspection system;

FIG. 8A illustrates a displaying example of a display in the present embodiment;

FIG. 8B illustrates a displaying example of the display in the present embodiment; and

FIG. 9 illustrates experimental results for confirming the validity of the present embodiment.

### DESCRIPTION OF EMBODIMENTS

### Embodiment

Hereinafter, an embodiment of the present disclosure will be described in detail with reference to the accompanying drawings. Note that, the embodiment described below is merely an example, and the present disclosure is not limited by the embodiment described below.

Hereinafter, an embodiment of the present disclosure will be described in detail with reference to the accompanying drawings as appropriate. Having said that, a detailed description more than necessary may be omitted, such as a detailed description of an already well-known matter and a duplicated description for a substantially identical configuration, to avoid the following description becoming unnecessarily redundant and to facilitate understanding by those skilled in the art.

Note that, the accompanying drawings and the following description are provided for those skilled in the art to sufficiently understand the present disclosure, and are not intended to limit the subject matter described in the claims.

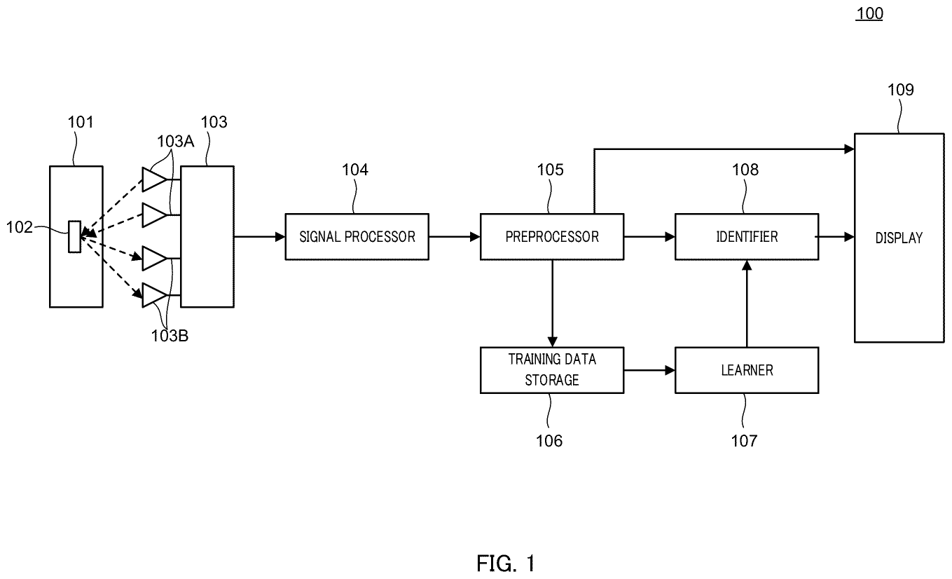

First, nondestructive inspection system 100 in the embodiment of the present disclosure will be described with reference to FIG. 1. FIG. 1 is a configuration diagram illustrating an example of nondestructive inspection system 100 in the embodiment of the present disclosure.

As illustrated in FIG. 1, nondestructive inspection system 100 is a system for inspecting the internal state of object to be measured 101 (for example, a board, a food, a package, or the like whose interior is not visible). For example, in a case where foreign object 102 is mixed inside object to be measured 101 (for example, a metal piece mixed in a board, or the like), nondestructive inspection system 100 makes it possible to inspect the internal state of object to be measured 101 without destroying object to be measured 101. Note that, besides foreign object 102 mixed inside object to be measured 101, nondestructive inspection system 100 is also capable of performing inspection in a case where any other defect such as a bubble (void) is included inside object to be measured 101.

Specifically, nondestructive inspection system 100 includes a central processing unit (CPU) (not illustrated), a read only memory (ROM) (not illustrated), a random access memory (RAM) (not illustrated), and input-output circuitry (not illustrated). Nondestructive inspection system 100 detects and identifies the internal state of object to be measured 101 by radiating a radio wave to object to be measured 101 and receiving a reflection wave thereof based on a preset program. Then, nondestructive inspection system 100 presents (displays) detection and identification results of the internal state of object to be measured 101 to the user.

Nondestructive inspection system 100 includes transceiver 103, signal processor 104, preprocessor 105, training data storage 106, learner 107, identifier 108, and display (monitor) 109.

Transceiver 103 includes a plurality of transmission antennas 103A and a plurality of reception antennas 103B, and is capable of transmitting and receiving a radio wave in the millimeter-wave band. Specifically, in transceiver 103, radio waves transmitted (wave-transmitted) from the plurality of transmission antennas 103A are radiated to object to be measured 101, and the plurality of reception antennas 103B receives reflection waves reflected by object to be measured 101. As transceiver 103, for example, a multiple-input and multiple-output (MIMO) radar apparatus of the frequency modulated continuous wave (FMCW) system may be used.

Signal processor 104 processes the signals (reflection wave) received by transceiver 103 and calculates phases and intensities between a plurality of transmission/reception waves. For signaling processing, signal processor 104 can use a method that is carried out for a typical radar apparatus of the FMCW system.

For example, in a case where an apparatus of the FMCW system is used, the distance to an object (object to be measured 101) and a relative velocity with respect to the object can be estimated by detecting a time difference between the transmission timing of a transmission signal and the reception timing of a reception signal, and a frequency difference therebetween due to the Doppler effect. Thus, it is possible to calculate phases and intensities both of which vary for each combination of the plurality of transmission antennas 103A and the plurality of reception antennas 103B.

Signal processor 104, for example, performs signals processing of a reception signal whose signal waveform is outputted as digital data, and converts the reception signal having been subjected to the signal processing into a matrix in which the rows are virtual arrays (the number of combinations of the plurality of transmission antennas and the plurality of reception antennas) and the columns are ranges (see, for example, FIG. 3). The range is the distance between transceiver 103 and object to be measured 101. The phases or intensities (or complex numbers indicating phases and amplitudes) calculated for each combination of the plurality of transmission antennas and the plurality of reception antennas become components of the matrix for each range.

Preprocessor 105 performs preprocessing of converting information on the phases and intensities between a plurality of transmission/reception signals calculated by signal processor 104 into data in a form easily identifiable by identifier 108 subsequent to preprocessor 105. Specifically, preprocessor 105 performs processing of converting relative phase differences and relative intensity differences between a plurality of transmission/reception waves based on radiation of radio waves to object to be measured 101 into a color image. The color image is a color image represented in a color space (HSV color space) including hue (H), saturation (S), and value or brightness (V).

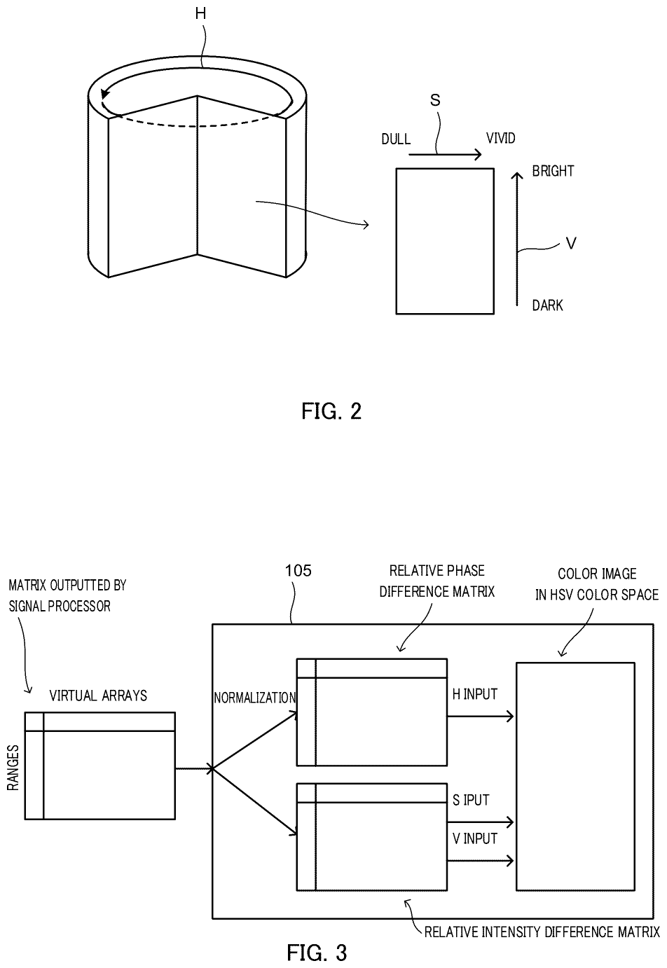

As illustrated in FIG. 2, hue H represents colors such as red, green, and blue on a hue circle of 0 to 360 degrees. Saturation S represents vividness of the colors with 0 to 100%. The saturation in FIG. 2 indicates, for example, that the colors become more vivid toward the right side of FIG. 2 and become duller toward the left side of FIG. 2. Value V represents brightness of the colors with 0 to 100%. The value in FIG. 2 indicates, for example, that the colors become brighter upward in FIG. 2 and become darker downward in FIG. 2.

As illustrated in FIG. 3, preprocessor 105 normalizes phases and intensities in the matrix from signal processor 104 such that the phases and intensities fall within predetermined ranges, calculates relative phase differences and relative intensity differences within the matrix, and converts the relative phase differences and relative intensity differences into predetermined numerical value expressions. More specifically, preprocessor 105 calculates a relative phase difference and a relative intensity difference by subtracting a component (phase or intensity) of a combination of the transmission antennas and the reception antennas, which corresponds to, for example, the first row, from a component (phase or intensity) of another row for each range (for each column). Alternatively, preprocessor 105 may calculate a relative phase difference and a relative intensity difference by subtracting a component, which corresponds to, for example, the first column, from a component of another column for each row. Thus, a relative phase difference matrix and a relative intensity difference matrix in both of which ranges are the columns and virtual arrays are the rows are generated.

Then, preprocessor 105 converts calculated relative phase differences (for example, in a range between −2π and 2π) into numerical value expressions in a predetermined range. Further, preprocessor 105 converts calculated relative intensity differences into numerical value expressions in a predetermined range. The numerical value expression in the predetermined range may be, for example, a real number value of 0 to 1.0 or may be an integer value of 0 to 255.

Preprocessor 105 generates a color image by assigning a relative phase difference matrix to hue H in the HSV color space and assigning a relative intensity difference matrix to saturation S and value V in the HSV color space. In this manner, it is possible to generate a color image that represents continuity of phases (no phase jump from −π to π occurs) with continuity in the hue circle.

In addition, preprocessor 105 outputs a color image to display 109. In this case, preprocessor 105 may output a color image in the HSV color space or may output a color image in the RGB color space into which a color image in the HSV color space has been converted.

As illustrated in FIG. 1, training data storage 106 associates a color image of object to be measured 101, whose internal state is known, with an internal state label indicating the content of the type of the internal state thereof, and stores the color image in association with the internal state label as training data for internal state identification learning.

Specifically, before learning by learner 107, for example, nondestructive inspection system 100 measures object to be measured 101, of which the type of the internal state (for example, a normal product (a products without any defect), with a foreign object(s), with a bubble(s), or the like) is known, and associates a color image (second color image) subjected to the conversion by preprocessor 105 with an internal state label (ground truth label), and stores a large amount of the color images as such in association with the internal state labels as such in training data storage 106.

Note that, a color image (second color image) to be stored in training data storage 106 is an object to be measured used for learning by learner 107, and is therefore a color image for which an object to be measured with a known internal state has been measured and which has been processed by preprocessor 105. Further, a plurality of samples of a second color image for each type of the internal state, where each type has been assumed in advance, is stored in training data storage 106.

Learner 107 learns an identification model for identifying the type of the internal state by using training data. Details of learner 107 will be described later.

Identifier 108 includes the identification model described above. Identifier 108 identifies the type of the internal state of object to be measured 101 according to a color image processed by preprocessor 105 by using the identification model. As the identification model, a model such as a neural network is used. In the identification model, parameters learned by learner 107 are used.

Identifier 108 identifies the type of the internal state and predicts the internal state label described above. Identifier 108 outputs a prediction label which is a result of the prediction of the internal state label. Further, identifier 108 also outputs, simultaneously with the prediction label, information on an embedding space (feature vector(s)) to be described later. Details of identifier 108 will be described later.

Display 109 is a displaying apparatus capable of displaying a color image processed by preprocessor 105, a prediction label which is an identification result of identifier 108, and information on an embedding space from identifier 108 to the user. For example, a user interface such as a display with a touch screen, or the like, is used as display 109. The user can judge the internal state of object to be measured 101 via display 109 and can determine whether object to be measured 101 is a good product or a defective product.

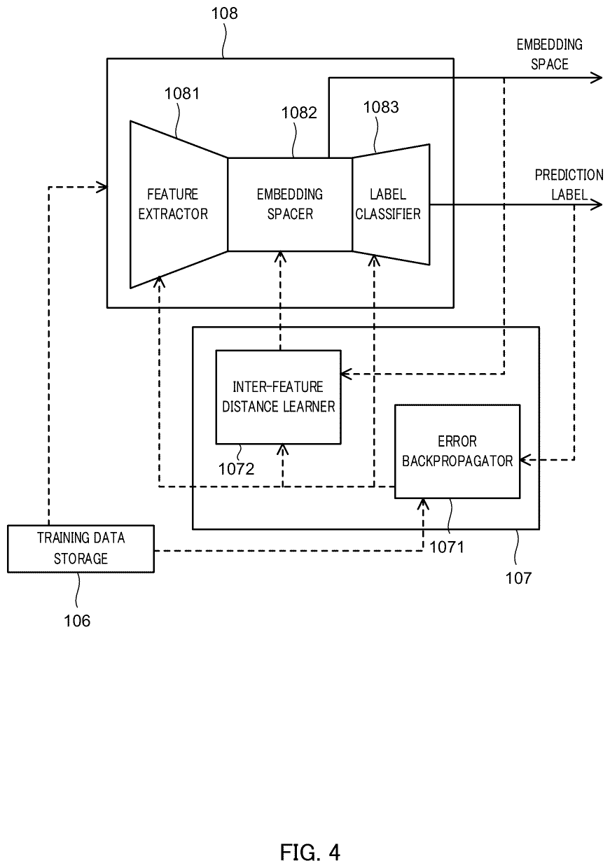

Next, details of learner 107 and identifier 108 will be described. FIG. 4 illustrates exemplary internal configurations of learner 107 and identifier 108.

As the identification model in identifier 108 in the present embodiment, a convolution neural network (CNN) is used. As illustrated in FIG. 4, identifier 108 performs processing of embedding a feature vector(s) in an embedding space, which is a low-dimensional space, by using the aforementioned identification model. Identifier 108 includes feature extractor 1081, embedding spacer 1082, and label classifier 1083.

Feature extractor 1081 extracts a feature(s) for a color(s) of a color image inputted from preprocessor 105 and/or for arrangement thereof by using the convolution neural network. As described above, feature extractor 1081 may use a neural network having a structure other than that of the convolution neural network that is relatively often used in image recognition.

Embedding spacer 1082 performs processing of embedding (mapping) a high-dimensional vector(s), which indicate(s) the feature(s) extracted by feature extractor 1081, as a low-dimensional vector(s) in a low-dimensional embedding space. The embedding space may be a two-dimensional or three-dimensional space that can be easily visualized. Further, embedding spacer 1082 may be implemented in a fully connected neural network that converts an output of the convolution neural network into two outputs or three outputs.

Label classifier 1083 acquires the low-dimensional vector(s) subjected to the conversion by embedding spacer 1082, and outputs a prediction label. Label classifier 1083 converts a two-dimensional or three-dimensional low dimensional vector(s) into an output of a prediction label according to the type of the internal state to be identified. As label classifier 1083, various neural networks or classification algorithms such as the k-Nearest Neighbor (kNN) method and a support vector machine (SVM) can be used.

As described above, in identifier 108, feature extractor 1081, embedding spacer 1082, and label classifier 1083 in this order process a color image, and identifier 108 outputs the information on the embedding space including the low-dimensional vector(s) subjected to the conversion by embedding spacer 1082, and the prediction label classified by label classifier 1083.

Learner 107 performs metric learning by using the feature(s) embedded in the embedding space by identifier 108. Specifically, learner 107 performs learning, by using the low-dimensional vector(s) (hereinafter referred to as the feature vector(s)) and the prediction label both of which have been outputted by identifier 108, such that the prediction label coincides with the training data. Learner 107 includes error backpropagator 1071 and inter-feature distance learner 1072.

Error backpropagator 1071 calculates an error between a prediction label and a ground truth label in training data storage 106, and adjusts parameters of the identification model such that the error is reduced.

Examples of the parameters of the identification model include weights and bias values of neurons in feature extractor 1081 and label classifier 1083, and error backpropagator 1071 adjusts these parameters according to the error.

Inter-feature distance learner 1072 performs processing of adjusting the distance between feature vectors with the same ground truth label with respect to a first feature vector outputted by identifier 108. Specifically, inter-feature distance learner 1072 adjusts the parameters of the identification model such that the distance between feature vectors obtained by converting inputted images including the same internal state label in the training data decreases, and such that the distance between feature vectors obtained by converting inputted images including different internal state labels in the training data increases.

Examples of the parameters of the identification model include a weight and a bias value of a neuron in embedding spacer 1082, and inter-feature distance learner 1072 adjusts these parameters.

Here, the first feature vector is obtained by converting an inputted image associated with a given ground truth label. A second feature vector is obtained by converting another inputted image associated with the same ground truth label as the ground truth label of the first feature vector. Further, a third feature vector is obtained by converting another inputted image associated with a ground truth label different from the ground truth label of the first feature vector. For example, inter-feature distance learner 1072 adjusts the parameters such that the first feature vector approaches the second feature vector and is away from the third feature vector.

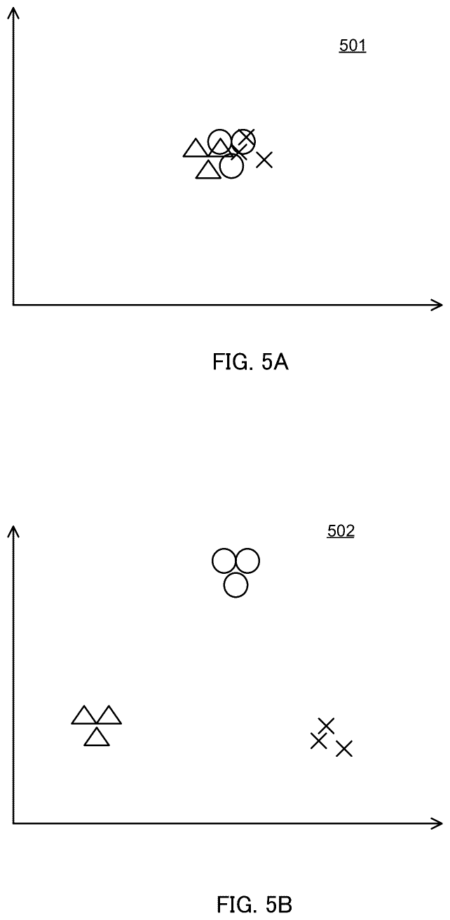

For example, as illustrated in FIG. 5A, in embedding space 501 before learning by learner 107, each feature vector is disposed (converted) centered on the vicinity of one position, regardless of the types of the internal state labels (because it is still difficult to perform identification). Note that, the exemplified embedding space is a two-dimensional embedding space. Further, in FIGS. 5A and 5B, “◯” indicates a normal product, “Δ” indicates: with a foreign object(s), and “X” indicates: with a bubble(s).

In contrast, as illustrated in FIG. 5B, learning by learner 107 causes each feature vector to be distributed and disposed (converted) for each content of the internal state labels in embedding space 502. Specifically, each feature vector is disposed such that feature vectors with the same type of the internal state label are located in positions different from those of feature vectors with different types of internal state labels.

This allows nondestructive inspection system 100 to easily identify the types of the internal states with similar features depending on which internal state label on the embedding space a feature vector is mapped close to. Further, since a feature vector can be mapped in a position away from each internal state label on the embedding space, nondestructive inspection system 100 makes it easier for the user to recognize the rationale for an internal state not being included in the training data (which is an unknown defective condition).

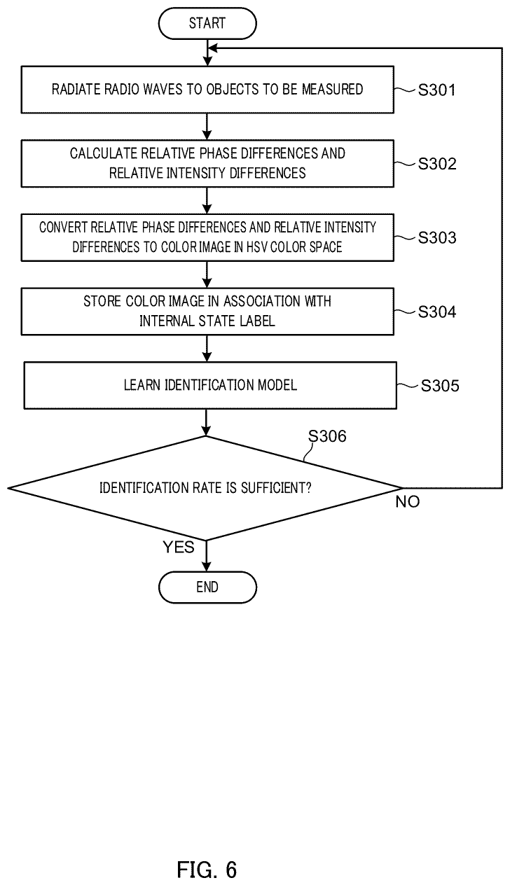

Next, an operation example of nondestructive inspection system 100 will be described. First, an operation example of learning control by learner 107 will be described. FIG. 6 is a flowchart illustrating an operation example of learning control by learner 107 of nondestructive inspection system 100.

In addition, the processing in FIG. 6 assumes that, for example, a plurality of objects to be measured 101 with specified internal states, which is assumed to be samples of the training data, is prepared. The plurality of objects to be measured 101 is prepared such that among the plurality of objects to be measured 101, each number of those with the same type of the internal state is substantially the same as each type of the internal states.

As illustrated in FIG. 6, nondestructive inspection system 100 causes transceiver 103 to radiate radio waves to objects to be measured 101 (step S301). After the radio waves are radiated and transceiver 103 receives reflection waves from objects to be measured 101, nondestructive inspection system 100 causes preprocessor 105 to calculate relative phase differences and relative intensity differences between the plurality of transmission antennas 103A and the plurality of reception antennas 103B (step S302).

After the relative phase differences and the relative intensity differences are calculated, nondestructive inspection system 100 causes preprocessor 105 to convert the relative phase differences and the relative intensity differences to a color image in the HSV color space (step S303). Then, nondestructive inspection system 100 stores the color image in association with an internal state label in training data storage 106 (step S304).

Next, nondestructive inspection system 100 causes learner 107 to learn the identification model (step S305). After the identification model is learned, nondestructive inspection system 100 causes learner 107 to determine whether the identification rate is sufficient (step S306).

The identification rate may be, for example, the percentage of the number of correct answers in a case where all of the plurality of objects to be measured 101 are samples for a test. Further, with respect to the determination criterion for whether the identification rate is sufficient, for example, it can be configured such that the identification rate is determined to be sufficient in a case where the identification rate is equal to or greater an arbitrary value (for example, 90% or the like).

As a result of the determination, in a case where the identification rate is insufficient (step S306, NO), the processing returns to step S301 and the learning flow is repeated again. In a case where the identification rate is sufficient (step S306, YES), on the other hand, the present control ends.

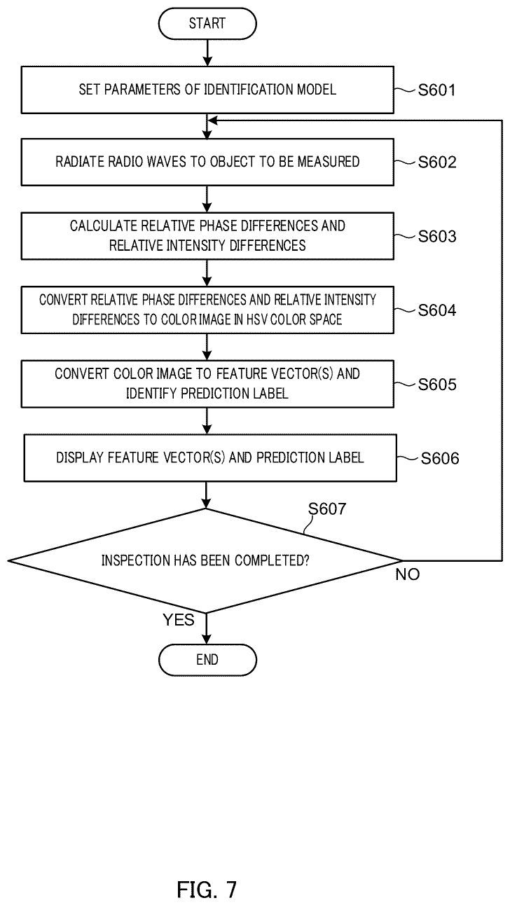

Next, an operation example of inspection control in nondestructive inspection system 100 will be described. FIG. 7 is a flowchart illustrating an operation example of inspection control in nondestructive inspection system 100. The processing in FIG. 7 assumes that object to be measured 101 as an object to be inspected is prepared.

As illustrated in FIG. 7, nondestructive inspection system 100 sets the parameters of the identification model in identifier 108 (step S601). The parameters of the identification model in this case is/are that/those adjusted by learning by learner 107.

Nondestructive inspection system 100 causes transceiver 103 to radiate radio waves to object to be measured 101 (step S602). After the radio waves are radiated and transceiver 103 receives reflection waves from object to be measured 101, nondestructive inspection system 100 causes preprocessor 105 to calculate relative phase differences and relative intensity differences between the plurality of transmission antennas 103A and the plurality of reception antennas 103B (step S603).

After the relative phase differences and the relative intensity differences are calculated, nondestructive inspection system 100 causes preprocessor 105 to convert the relative phase differences and the relative intensity differences to a color image in the HSV color space (step S604). After the conversion into the color image, nondestructive inspection system 100 causes identifier 108 to convert the color image to a feature vector(s) and to identify the prediction label (step S605). Nondestructive inspection system 100 then causes display 109 to display the feature vector(s) and the prediction label (step S606).

Thereafter, nondestructive inspection system 100 determines whether the inspection has been completed (step S607). As a result of the determination, in a case where the inspection has not been completed (step S607, NO), the processing returns to step S602. In a case where the inspection has been completed (step S607, YES), on the other hand, the control ends.

Next, displaying examples of results of inspection of by nondestructive inspection system 100 in the present embodiment will be described.

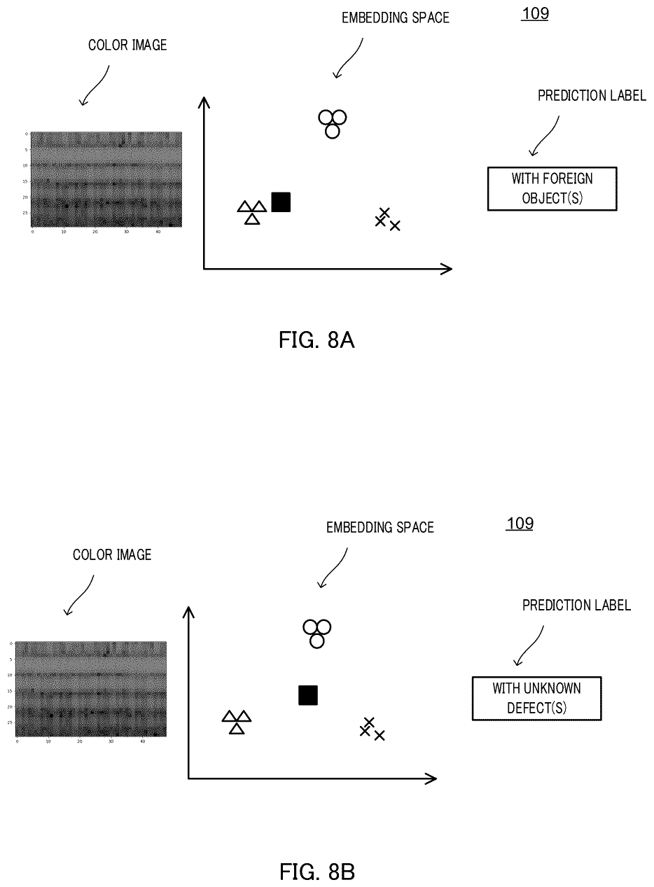

For example, as illustrated in FIGS. 8A and 8B, display 109 displays the color image which is generated by preprocessor 105, the embedding space and the feature vectors both of which are generated by embedding spacer 1082, and the prediction label which is the identification result. The object to be measured as the object to be inspected is indicated with “▪” within the embedding space.

In FIG. 8A, since the object to be inspected is located in a position closest to the feature vectors “Δ” indicating “with a foreign object(s)”, the prediction label is described as, for example, “WITH FOREIGN OBJECT(S)”. As described above, since the prediction label and feature vectors in the embedding space are displayed, the user can recognize the rationale (certainty) for the type of the internal state in the prediction label as visual information. Note that, the displaying of the prediction label may be omitted. In addition, in a case where the distance between the object to be measured “▪” and: with a foreign object(s) “Δ” is within a predetermined range, displaying for appealing to the user may be performed, such as the object to be measured “▪” and: with a foreign object(s) “Δ” are displayed to flicker or are changed in color.

In FIG. 8B, the object to be inspected is located in a position midway among the feature vectors. In this case, since the object to be inspected is located in a position away from each feature vector, the prediction label describes, for example, “WITH UNKNOWN DEFECT(S)” or the like. As described above, the description in the prediction label allows the user to grasp that there is a defect(s) that is/are not in the training data, and enables the user to easily judge the rationale therefor by confirming the embedding space. Note that, the displaying of the “WITH UNKNOWN DEFECT(S)” may be omitted. Further, displaying for appealing to the user may be performed, such as the normal product “◯”, with a foreign object(s) “Δ”, with a bubble(s) “X”, and the object to be measured “▪” are displayed to flicker or are changed in color.

Further, identifier 108 can determine whether an “unknown defect(s)” is/are present, depending on whether the distance between the object to be inspected and each feature vector is equal to or greater than a predetermined threshold.

Note that, display 109 may display accumulated determination results of inspected samples. Thus, for a plurality of samples currently being inspected, it is possible for the user to confirm, at a glance, the degree of variations in the percentage of normal products or the like.

According to the present embodiment configured in the above-described manner, learner 107 performs learning by using a color image represented in the HSV color space. For example, since the identification model is learned by using a color image that represents continuity of phases with continuity in the hue circle, phase differences in the vicinity of ±π where a phase jump is likely to occur can be represented with similar colors. As a result, a learning effect for identifying the type of the internal state of an object to be measured, which is used in the training data, can be enhanced, and further the type of the internal state of the object to be measured can be identified accurately.

In addition, since relative phase differences are assigned to the hue, phase differences in the vicinity of ±π where a phase jump is likely to occur can be represented with similar colors. Further, since relative intensity differences are assigned to the saturation and the value, vividness of colors, brightness of the colors, and/or the like can be represented finely. As a result, since a color image that is more easily identifiable can be generated for the user and the identification model, the learning effect for identifying the type of the internal state of an object to be measured, which is used in the training data, can be further enhanced, and further the identification rate can be improved.

In addition, since identifier 108 outputs, in addition to the prediction label, the information (feature vector(s)) on the embedding space via the display, the rationale for judging which internal state a feature vector(s) close to the feature vector of an object to be measured include(s) or for judging whether the object to be measured includes an unknown defect(s) (unknown feature(s)) can be presented to the user. For example, since the user can easily recognize the rationale and certainty for identification in nondestructive inspection system 100, it is possible to make it easier for the user to judge whether an object to be measured is a good product or a defective product.

Further, in order to confirm the validity of nondestructive inspection system 100 according to the present embodiment, predetermined experiments were conducted. The predetermined experiments were experiments in which a board was used as an object to be measured and identification rates with respect to identification of three types of content states: a normal product, with a large bubble(s), and with a small bubble(s), and identification as to whether the object to be measured was a normal product were measured, respectively.

Further, as a comparative example, for example, the matrix generated by the signal processor was not converted into the HSV color space, but was converted directly into an image in the RGB color space (relative phase differences are directly assigned to R (red), and relative intensity differences are directly assigned to G (green) and B (blue)), and the identification rates described above were measured and compared with the identification rates in the present embodiment (present example).

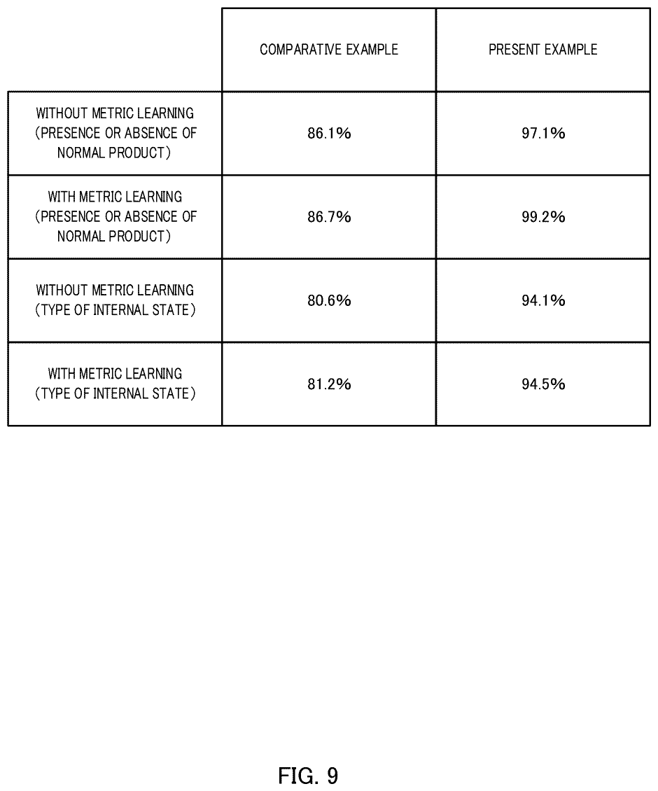

In addition, in the present experiments, both determination of the presence or absence of a normal product and determination of the type of the internal state were inspection items with respect to a case in which metric learning was not performed (without metric learning) and a case in which metric learning was performed (with metric learning). FIG. 9 indicates experimental results of the predetermined experiments.

As illustrated in FIG. 9, it was confirmed that the identification rate in each inspection item in the comparative example was less than 90%, whereas it was confirmed that the identification rate in each inspection item in the present example was equal to or greater than 90%. For example, it was confirmed that the identification rates were improved in the present example.

Further, it can be confirmed that the identification rates in a case where the metric learning was performed improved than the identification rates in a case where the metric learning was not performed. For example, it was confirmed that the identification rates improved by conducting the metric learning of the feature vector(s). The validity of the present example was confirmed thereby.

Note that, in the embodiment described above, relative intensity differences are assigned to the saturation and the value, but the present disclosure is not limited thereto, and relative intensity differences may be assigned to either the saturation and the value. Having said that, from the viewpoint of causing a color image to be easily recognized, relative intensity differences are preferably assigned to both the saturation and the value.

Further, in the embodiment described above, transceiver 103 is configured to receive reflection waves from an object to be measured, but the present disclosure is not limited thereto. In a case where an object to be measured is configured to be held between the transmitter and the receiver, the receiver may be configured to receive transmitted waves from the object to be measured.

In the embodiment described above, the notation “ . . . processor”, “ . . . -er”, “ . . . or” or “ . . . ar” used for each component may be replaced with another notation such as “ . . . circuitry”, “ . . . assembly”, “ . . . device”, “ . . . unit” or “ . . . module”.

Although the embodiment has been described above with reference to the accompanying drawings, the present disclosure is not limited to such examples. It is obvious that a person skilled in the art can arrive at various variations and modifications within the scope recited in the claims. It is understood that such variations and modifications also belong to the technical scope of the present disclosure. Further, components in the embodiment described above may be arbitrarily combined without departing from the spirit of the present disclosure.

The present disclosure can be realized by software, hardware, or software in cooperation with hardware. Each functional block used in the description of the embodiment described above can be partly or entirely realized by a large scale integration (LSI) such as an integrated circuit, and each process described in the embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a field programmable gate array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

In addition, each of the embodiment described above is only illustration of an exemplary embodiment for implementing the present disclosure, and the technical scope of the present disclosure shall not be construed limitedly thereby. For example, the present disclosure can be implemented in various forms without departing from the gist or the main features thereof.

### (Summary of Embodiment)

A learning apparatus according to an exemplary embodiment of the present disclosure includes: preprocessing circuitry, which, in operation, performs processing of converting relative phase differences and relative intensity differences between a plurality of transmission/reception waves based on radiation of radio waves to an object to be measured into a color image; and learning circuitry, which, in operation, learns, by using a first color image and training data, an identification model for identifying a type of an internal state of the object to be measured, where the training data are training data in which a second color image and the type of the internal state are associated and the first color image and the second color image being processed by the preprocessing circuitry.

A learning method according to an exemplary embodiment of the present disclosure is a learning method of a learning apparatus that identifies an internal state of an object to be measured. The learning method includes: performing processing of converting relative phase differences and relative intensity differences between a plurality of transmission/reception waves based on radiation of radio waves to the object to be measured into a color image including hue, saturation, and value; and learning, by using a first color image and training data, an identification model for identifying a type of the internal state, where the training data are training data in which a second color image and the type of the internal state are associated and the first color image and the second color image being processed.

A nondestructive inspection system of an exemplary embodiment for the present disclosure includes: preprocessing circuitry, which, in operation, performs processing of converting relative phase differences and relative intensity differences between a plurality of transmission/reception waves based on radiation of radio waves to an object to be measured into a color image including hue, saturation, and value; learning circuitry, which, in operation, learns, by using a first color image and training data, an identification model for identifying a type of an internal state of the object to be measured, where the training data are training data in which a second color image and the type of the internal state are associated and the first color image and the second color image being processed by the preprocessing circuitry; identification circuitry, which, in operation, identifies, by using the identification model, the type of the internal state of the object to be measured according to the first color image; and a monitor, which, in operation, displays an identification result of the identification circuitry.

The disclosure of Japanese Patent Application No. 2021-120434, filed on Jul. 21, 2021, including the specification, drawings and abstract, is incorporated herein by reference in its entirety.

### INDUSTRIAL APPLICABILITY

An exemplary embodiment of the present disclosure is useful for a learning apparatus, a learning method, and a nondestructive inspection system each capable of performing learning for accurately identifying the type of the internal state of an object to be measured, which is used in training data.

### REFERENCE SIGNS LIST

100 Nondestructive inspection system
101 Object to be measured
102 Foreign object
103 Transceiver
104 Signal processor
105 Preprocessor
106 Training data storage
107 Learner
108 Identifier
109 Display
1071 Error backpropagator
1072 Inter-feature distance learner
1081 Feature extractor
1082 Embedding spacer
1083 Label classifier

1. A learning apparatus, comprising:
preprocessing circuitry, which, in operation, performs processing of converting relative phase differences and relative intensity differences between a plurality of transmission/reception waves into a color image, the plurality of transmission/reception waves being based on radiation of radio waves to an object to be measured; and
learning circuitry, which, in operation, learns, by using a first color image and training data, an identification model for identifying a type of an internal state of the object to be measured, the training data being training data in which a second color image and the type of the internal state are associated, the first color image and the second color image being processed by the preprocessing circuitry.

2. The learning apparatus according to claim 1, wherein the preprocessing circuitry assigns the relative phase differences to hue and assigns the relative intensity differences to at least one of saturation and/or value.

3. The learning apparatus according to claim 1, comprising identification circuitry, which, in operation, identifies, by using the identification model, the type of the internal state of the object to be measured according to the first color image, wherein
the learning circuitry adjusts a parameter of the identification model according to an identification result of the identification circuitry and according to the training data.

4. The learning apparatus according to claim 3, wherein:
the identification circuitry predicts, by using a neural network to extract a first feature vector of the first color image and by embedding the first feature vector in a low-dimensional space, the type of the internal state of the object to be measured, and
the learning circuitry adjusts the parameter of the identification model such that the first feature vector and a second feature vector of the second color image substantially coincide, the first feature vector being in a prediction internal state predicted by the identification circuitry, the second color image being associated with an internal state whose type is identical to the type of the internal state of the object to be measured according to the first color image in the training data.

5. The learning apparatus according to claim 4, wherein the learning circuitry adjusts the parameter of the identification model such that a distance between the first feature vector and the second feature vector is shorter than a distance between a third feature vector of a third color image and the first feature vector, the third color image being associated with an internal state whose type is different from the type of the internal state of the object to be measured according to the first color image in the training data.

6. The learning apparatus according to claim 5, wherein the identification circuitry outputs information on the low-dimensional space.

7. A learning method of a learning apparatus that identifies an internal state of an object to be measured, the learning method comprising:
performing processing of converting relative phase differences and relative intensity differences between a plurality of transmission/reception waves into a color image, the plurality of transmission/reception waves being based on radiation of radio waves to the object to be measured, the color image including hue, saturation, and value; and
learning, by using a first color image and training data, an identification model for identifying a type of the internal state, the training data being training data in which a second color image and the type of the internal state are associated, the first color image and the second color image being processed.

8. A nondestructive inspection system, comprising:
preprocessing circuitry, which, in operation, performs processing of converting relative phase differences and relative intensity differences between a plurality of transmission/reception waves into a color image, the plurality of transmission/reception waves being based on radiation of radio waves to an object to be measured, the color image including hue, saturation, and value;
learning circuitry, which, in operation, learns, by using a first color image and training data, an identification model for identifying a type of an internal state of the object to be measured, the training data being training data in which a second color image and the type of the internal state are associated, the first color image and the second color image being processed by the preprocessing circuitry;
identification circuitry, which, in operation, identifies, by using the identification model, the type of the internal state of the object to be measured according to the first color image; and
a monitor, which, in operation, displays an identification result of the identification circuitry.
